(19) United States
(12) Patent Application Publication
(10) Pub. No.: US 2026/0175792 A1
(43) Pub. Date: Jun. 25, 2026

(54) SENSOR MODULE FOR A MOTOR VEHICLE

(71) Applicant: Webasto SE, Stockdorf (DE)

(72) Inventors: Thomas PODOLSKI, Stockdorf (DE); Nikolaus LINNER, Stockdorf (DE)

(21) Appl. No.: 19/406,070

(22) Filed: Dec. 2, 2025

(30) Foreign Application Priority Data
Dec. 19, 2024 (DE) 10 2024 138 852.8

(51) Int. Cl. B60R 11/04; B60R 11/00; G01S 7/02; G01S 7/521

(52) U.S. Cl. CPC B60R 11/04; B60R 2011/004; B60R 2011/0043; G01S 7/027; G01S 7/521

(57) ABSTRACT

A sensor module for a motor vehicle having an environment sensor for sensing an environment of the vehicle, a sensor module tray, a drive and an adjustment mechanism, the sensor module tray defining a wet region in which the environment sensor and at least a part of the adjustment mechanism are arranged, the sensor module tray realizing an interface to a dry region, and at least a part of the drive being arranged in the dry region and being connected via the interface to the adjustment mechanism for the purpose of adjusting the environment sensor.

### CROSS-REFERENCE TO RELATED APPLICATION(S)

This application claims the benefit of German Application No. DE 10 2024 138 852.8 filed December 19, 2024, which is incorporated herein by reference in its entirety.

### TECHNICAL FIELD

A sensor module for a motor vehicle. The invention also relates to a vehicle roof comprising such a sensor module and/or to a motor vehicle comprising such a vehicle roof and/or to such a sensor module.

### BACKGROUND

Vehicle roofs are well known from practice. A vehicle roof may be realized, for example, as a roof sensor module that can be mounted as a separate structural unit on a vehicle body shell of a passenger car. As an interface to the vehicle roof, the vehicle body comprises roof rails, which may be realized as longitudinal rails and/or transverse rails and constitute a support means on the vehicle body. The vehicle roof comprises a roof skin that forms an outer visible surface and has sensor transparency regions through which environment sensors, which serve to sense an environment of the vehicle and are arranged under the roof skin, can sense the environment of the vehicle.

Autonomous, or partly autonomous, vehicles comprise, for example, a roof realized as a sensor-roof module, or roof sensor module (RSM), that is equipped with a plurality of environment sensors. The environment sensors, which are integrated in a dry region in the vehicle roof that is realized in particular as a roof sensor module, and which are realized, for example, as lidar sensors and/or as radar sensors and/or as cameras, sense the environment around the vehicle and provide corresponding measurement signals to control electronics of the vehicle in question, such that a respective traffic situation can be determined and the driving behavior of the vehicle in question can be adapted to this traffic situation.

One of the greatest challenges in the development of such RSM systems is to protect the sensitive electronic and mechanical components inside from external influences such as water, dust and temperature fluctuations, while at the same time maintaining the unrestricted mobility and functionality of the module.

At the center of current developments is the integration of a flexible seal. Bellows or watertight membranes are often used for this purpose, which are designed to ensure complete tightness while still supporting mechanical mobility. These flexible structures must both ensure a watertight connection between the fixed and moving parts of the module and fulfil the requirements for durability and robustness in demanding environments.

The complexity of the design and the selection of suitable materials pose significant challenges. This is because both the sealing structure itself and the transition interfaces between the various module parts must be realized with precision in order to ensure the long-term functionality and reliability of the system. These requirements result in increased resource input in design, production and assembly, while at the same time there is a need to make the systems cost-efficient and easy to maintain.

### SUMMARY

It is therefore an object of the invention to specify an improved sensor module.

The object is achieved by a sensor module having the features of claim 1.

Advantageous embodiments of the invention constitute the subject-matter of the dependent claims. All combinations of at least two features disclosed in the description, the claims and/or the figures fall within the scope of the invention. In this regard, it is understood, in particular, that customary linguistic transformations and/or an analogous replacement of respective terms in the context of customary linguistic practice, in particular the use of synonyms supported by generally recognized linguistic literature, are included in the content of the present disclosure without being explicitly mentioned in their respective formulation.

In a preferred aspect, a sensor module for a motor vehicle is proposed. The sensor module has an environment sensor for sensing an environment of the vehicle, a sensor module tray, a drive and an adjustment mechanism, the sensor module tray defining a wet region in which the environment sensor and at least a part of the adjustment mechanism are arranged, the sensor module tray realizing an interface to a dry region, and at least a part of the drive being arranged in the dry region and being connected via the interface to the adjustment mechanism for the purpose of adjusting the environment sensor.

The sensor module has a sensor module frame, realized as a sensor module tray. This sensor module tray is preferably realized as a tray that is open on the roof side. The sensor module tray acts here as a separating barrier between the wet region, realized inside the tray, and the dry region, realized outside of the sensor module tray. The sensor module tray thus preferably seals off the vehicle roof skin on the inside. There is thus no need for a flexible seal such, for example, as a water bag. Inside the tray, the sensor module tray realizes the wet region, which serves as an installation space for the wet-region components of the sensor module within the sensor module tray. In this way, all components of the sensor module that are suitable for being located in the wet region can be placed inside the sensor module tray (e.g. adjustment mechanism, environment sensor, and/or cleaning nozzles, etc.). On the other hand, all components of the sensor module that are not suitable or less suitable for being located in the wet region (defined by the respective IP protection class of the components) can be placed outside of the wet region, in the dry region. The interface in the sensor module tray is provided to separate the wet region from the dry region. The interface can then provide a watertight seal between the wet region and the dry region. For this purpose, the interface may realize, for example, one or more sealing surfaces against which sealing arrangements can bear in a sealing manner.

The drive especially is usually not designed to be watertight due to its complexity and cost and is therefore particularly preferably placed in the dry region, which is protected from water and/or moisture. For reasons of practicality, the adjustment mechanism is preferably placed in the wet region. In order to provide a watertight interface between the drive and the kinematics, the drive and the sensor module tray may each realize a sealing interface.

In this case, it is possible that the drive does not need to be completely sealed. There is therefore no need for expensive, sophisticated and/or complex sealing of cables or connectors. Moreover, an inexpensive and simple, in particular waterproof, interface can be provided. Also, simple assembly can be achieved with fewer assembly steps. In addition, the flexible seal, for example a water bag, can be omitted. This reduces the overall cost of the sensor module.

In a further aspect, it is proposed that the sensor module tray has an opening that realizes the interface, at least a part of the adjustment mechanism or at least a part of the drive extending through the opening.

The opening may be provided, for example, as a cutout in a wall of the sensor module tray. The wall of the sensor module tray may define, around the opening, an edge region that is designed for sealing. The opening is preferably dimensioned in such a way that part of the drive or part of the adjustment mechanism can extend through it. This creates a transition between the dry region and the wet region that is particularly simple in design and easy to produce. 'Extend through' means here that at least a part or a component of the drive or of the adjustment mechanism protrudes from the wet region into the dry region, or protrudes from the dry region into the wet region. The respective part does not have to protrude completely, but may also protrude only partly.

In a further aspect, it is proposed that the drive has a drive housing, a motor-side bearing arrangement and a drive shaft, the drive housing being arranged in the dry region on the sensor module tray, the motor-side bearing arrangement extending at least partly through the opening into the wet region, and the drive shaft being arranged in the wet region and being connected to the adjustment mechanism for the purpose of adjusting the environment sensor.

The drive housing is preferably mounted on an outer wall of the sensor module tray, in the dry region. The outer wall is preferably orientated toward the inside of the vehicle. The motor-side bearing arrangement is preferably coupled to the drive shaft. An integral design is also possible. The drive shaft is arranged in the wet region and is preferably held in a movable manner on one side in a bearing arrangement. The drive shaft preferably engages in the adjustment mechanism in order to adjust the environment sensor. The motor may have a drive pinion. The drive pinion may be realized as a drive gear.

In a further aspect, it is proposed that the sensor module has a sealing means, which is arranged between the motor-side bearing arrangement and a wall of the sensor module tray that surrounds the opening.

The sealing means may have an O-ring seal. The motor-side bearing arrangement preferably has an external running surface for the sealing means. The sealing means preferably slides on the rotating running surface. The sensor module tray preferably comprises an internal mounting surface on which the sealing means is arranged. The sealing means is thus preferably firmly seated in the sensor module tray. A sealing pressure is preferably ensured radially by suitably designed diameters including tolerances of the first sealing means. However, the sealing means may also optionally be omitted if a pure wet space solution is not being sought.

In a further aspect, it is proposed that the sensor module has a second sealing means, which is arranged between the drive housing and the wall of the sensor module tray that surrounds the opening.

The drive housing preferably has an external running surface for the second sealing means. The second sealing means preferably seals to an internal housing geometry within the drive. Any fixed sealing geometry may be defined between the sensor module tray and the drive housing. Preferably, the second sealing means is an O-ring seal. A sealing pressure is preferably ensured axially (in the mounting direction) by suitably designed geometries including tolerances. The second sealing means may optionally be omitted if a pure wet space solution is not being sought. Two options may be defined for the drive (with/without seal).

In a further aspect, it is proposed that the sensor module has a spindle subassembly, comprising a coupling element, a bearing arrangement and a drive shaft that is connected to the coupling element, the drive having a coupling interface and a drive housing, the bearing arrangement being arranged on the coupling element and, starting from the wet region, extending through the opening into the dry region, the coupling interface, starting from the dry region, engaging in the coupling element, and the drive housing being arranged in the dry region on the sensor module tray.

Following mounting of the spindle subassembly, the drive is fastened to the sensor module tray from the outside. Preferably in this case, the coupling interface (preferably gear wheel) of a motor of the drive is inserted into the coupling element of the spindle subassembly.

The bearing arrangement of the drive shaft may preferably have a plain bearing and a ball bearing. In this design, the axial forces are preferably taken up by the ball bearing in the spindle subassembly. The drive therefore does not have to take up these axial forces. This makes the drive quieter. The elimination of the axial forces within the drive also results in less power loss, due to the simpler design within the drive. Consequently, a smaller drive can preferably be selected, which in turn results in a smaller installation space and lower costs. It is also possible to use an available standard drive. In this case, the coupling element may be adapted to the respective drive interface.

In a further aspect, it is proposed that the spindle subassembly has a sealing arrangement that is arranged, in particular in a sliding manner, between the bearing arrangement and a wall of the sensor module tray that surrounds the opening.

The coupling element may have an external running surface for the sealing arrangement. The sealing arrangement preferably slides on the rotating running surface. The sensor module tray preferably has an internal mounting surface. The sealing arrangement preferably has an O-ring seal. The sealing arrangement is preferably firmly seated in the sensor module tray. The separate spindle subassembly is preferably first mounted inside the sensor module tray. The coupling element, including the sealing arrangement and first bearing arrangement, is preferably inserted into the frame interface. The opposite, second bearing arrangement is then fastened to the sensor module tray using the bearing holder.

In a further aspect, it is proposed that the adjustment mechanism has a lever arrangement by means of which the environment sensor can be adjusted, and at least a part of the lever arrangement is connected to the drive for the purpose adjusting the environment sensor.

The lever arrangement may have a plurality of levers that enable a rotational and/or translational adjustment movement of the environment sensor when the lever arrangement is driven by the drive. For this purpose, for example, the drive shaft, or drive spindle, may engage in a guide lever of the lever arrangement and via this introduce the drive force, or drive torque, for the purpose of moving the environment sensor. The lever arrangement may preferably be realized in such a way that it adjusts the environment sensor between a retracted position and an extended position. The lever arrangement may preferably be designed to fix the drive in the retracted and/or extended position.

Also claimed in the present case is vehicle roof of a motor vehicle, comprising at least one such sensor module is.

A preferred embodiment of the vehicle roof is realized as a roof sensor module. Such a roof sensor module forms, in an integrated manner, a structural unit that accommodates components that are required for autonomous or partly autonomous driving of the vehicle in question. The roof sensor module, in which a plurality of functional elements can thus be integrated, therefore constitutes a compact structural unit that is connected by a vehicle manufacturer to a vehicle body, or a vehicle body shell, that comprises roof rails, such as roof side rails and/or roof longitudinal rails. The vehicle roof realized as a roof sensor module thus constitutes a sensor-roof module, or roof sensor module (RSM), that enables autonomous or partly autonomous driving of the vehicle in question.

A motor vehicle equipped with such a vehicle roof and realized as an autonomously driving vehicle drives independently in autonomous driving mode, at least without significant intervention by a driver. In a partly autonomous driving mode, the vehicle roof according to the invention forms, for example, part of a driver assistance system.

The vehicle roof may be provided with a transparent fixed roof portion and/or with a roof opening system for a roof opening.

In particular, the vehicle roof forms, at least partly a roof of a passenger car. However, it may also be a roof of a commercial vehicle that is realized, for example, as a delivery van, a bus, an autonomous minibus, such as a so-called people mover, or also as a truck tractor unit.

Also claimed in the present case is a motor vehicle, which comprises a sensor module and/or a vehicle roof of the type described above. The vehicle roof preferably realizes a roof sensor module (RSM) that can be arranged as a pre-assembled structural unit on a vehicle body of the motor vehicle. In other words, in particular a vehicle body shell of the motor vehicle can be provided with a prefabricated, or pre-assembled, roof sensor module that is realized as a sensor-roof module, or roof sensor module.

It is understood that the embodiments and exemplary embodiments mentioned above and to be explained below may be realized not only individually, but also in any combination with one another, without departing from the scope of the present invention. It is likewise understood that the embodiments and exemplary embodiments mentioned above and to be explained below relate in an equivalent or at least similar manner to all embodiments of the invention, without being mentioned separately in each case.

### BRIEF DESCRIPTION OF DRAWINGS

Embodiments of the invention are represented schematically in the drawings and are explained below as examples.

FIG. 1 shows a schematic representation of a vehicle roof having a sensor module.

FIG. 2 shows a schematic view of an exemplary embodiment of a sensor module.

FIG. 3 shows a schematic view of an exemplary embodiment of a sensor module.

FIG. 4 shows a schematic view of an exemplary embodiment of a sensor module.

FIG. 5 shows a schematic view of an exemplary embodiment of a sensor module.

FIG. 6 shows a schematic view of an exemplary embodiment of a sensor module.

FIG. 7 shows a schematic view of an exemplary embodiment of a sensor module.

FIG. 8 shows a schematic view of an exemplary embodiment of a sensor module.

FIG. 9 shows a schematic view of an exemplary embodiment of a sensor module.

FIG. 10 shows a schematic view of an exemplary embodiment of a sensor module.

### DETAILED DESCRIPTION

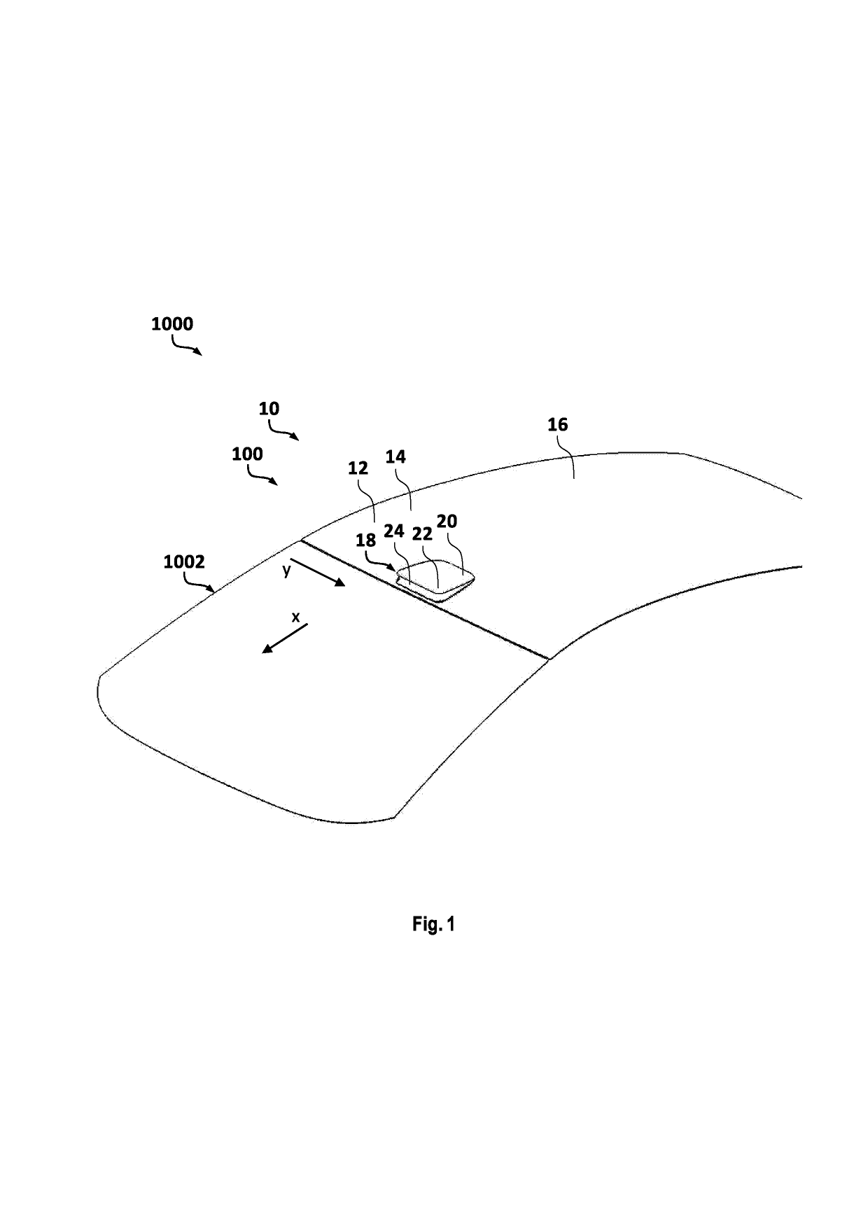

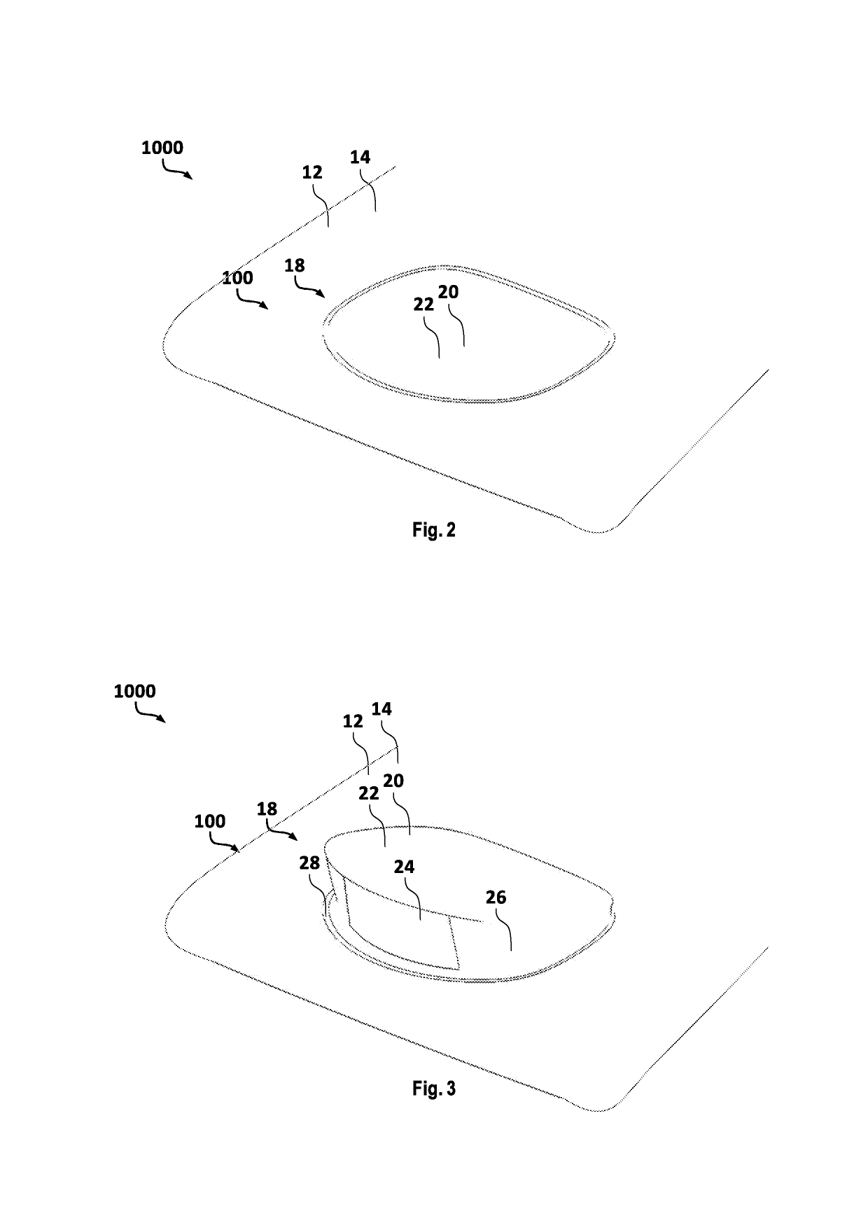

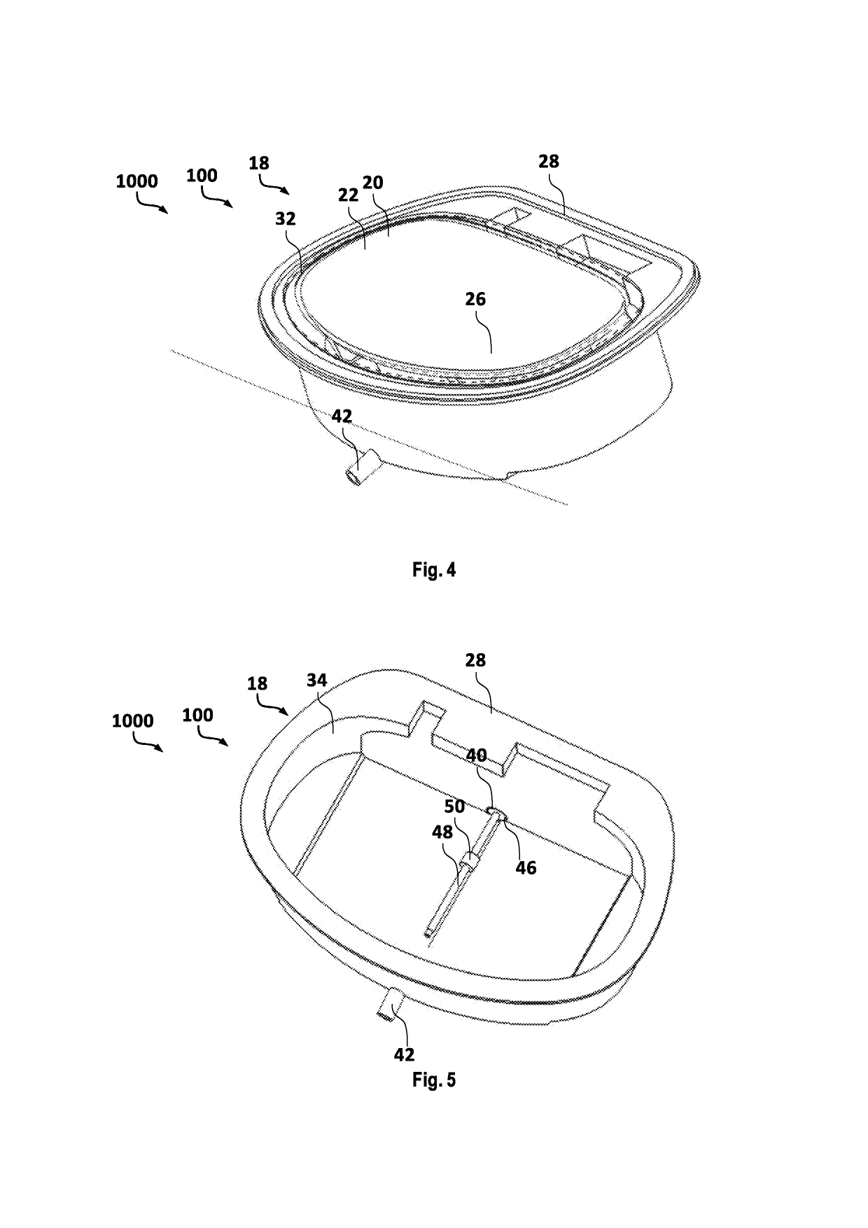

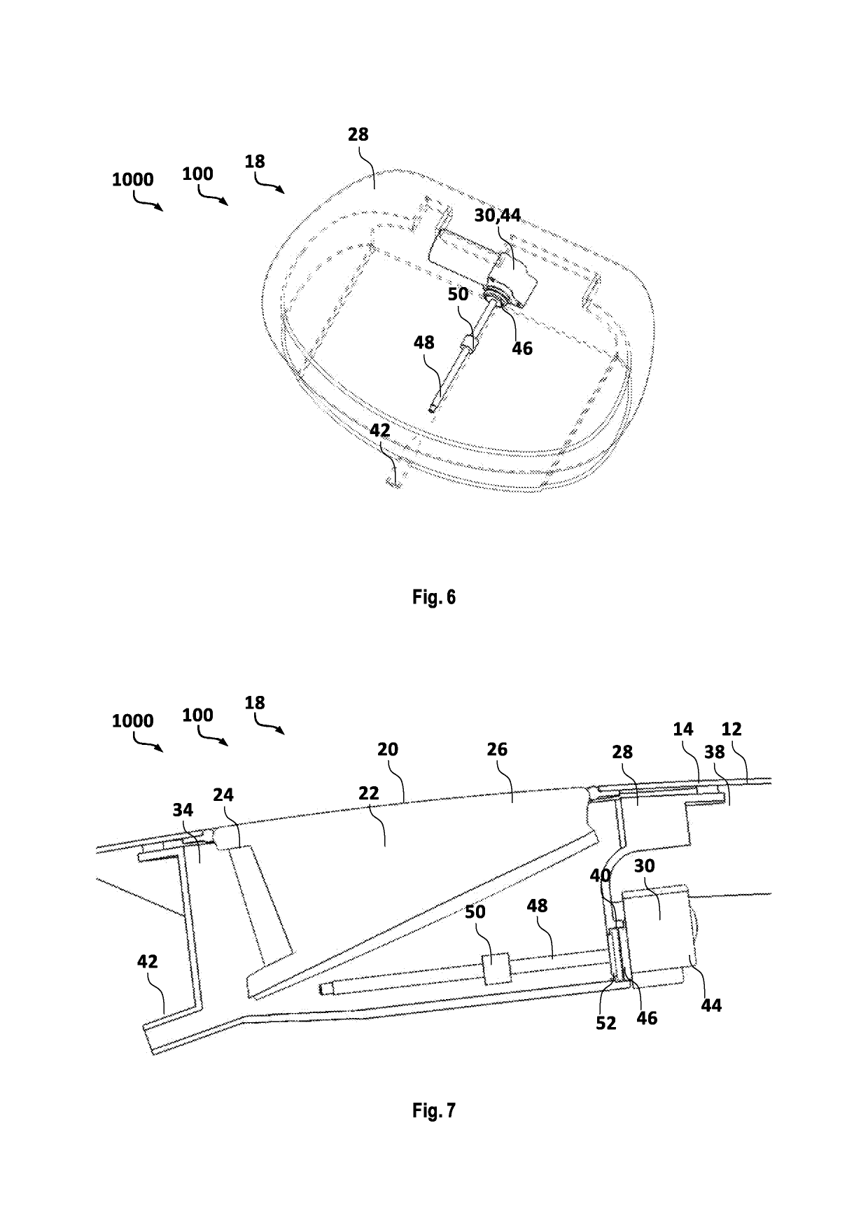

Shown schematically in FIG. 1 is a motor vehicle 1000 that has a vehicle body 1002. The motor vehicle 1000 also has a roof sensor module 10, which is arranged as a structural unit on the vehicle body 1002 and forms a vehicle roof 100 of the motor vehicle 1000, at least in some regions. The roof sensor module 10 may be provided as a pre-assembled structural unit. The vehicle roof 100 extends along a vehicle longitudinal direction x and along a vehicle width direction y. The vehicle longitudinal direction x is orientated orthogonally with respect to the vehicle width direction y.

In alternative embodiments, the vehicle roof 100 may also be a vehicle roof that is not realized as a roof sensor module. All remarks therefore also relate to such a vehicle roof 100.

The roof sensor module 10 comprises a surface component 12, which forms a roof skin 14 of the vehicle roof 100, at least in some regions. As shown by FIG. 1, the roof sensor module 10 comprises a fixed roof element 16, which forms an at least partially transparent area of the vehicle roof 100. In other or supplementary embodiments, the roof sensor module 10 may have a roof opening system comprising a cover element that can be displaced to selectively open or close a roof opening.

The roof sensor module 10, or the vehicle roof 100, has a sensor module 18. The sensor module 18 can have a cover 20. The sensor module 18 also has at least one environment sensor 22 for sensing an environment of the vehicle. The environment sensor 22 is configured to sense an environment of the vehicle via a transparency region 24. The transparency region 24 in this case is arranged on the cover 20. The environment sensor 22 may be a lidar sensor and/or a camera and/or a radar sensor and/or an ultrasonic sensor and/or a multi-camera sensor. Other sensors are also conceivable. The environment sensor 22 preferably has a sensor housing 26.

The sensor module 18 also has a sensor module tray 28, a drive 30 and an adjustment mechanism 32.

The sensor module tray 28 defines a wet region 34 in which the environment sensor 22 and at least part of the adjustment mechanism 32 are arranged. The sensor module tray 28 realizes an interface 36 to a dry region 38. At least a part of the drive 30 is arranged in the dry region 38 and is connected via the interface 36 to the adjustment mechanism 32 for the purpose of adjusting the environment sensor 22. The adjustment mechanism 32 has a lever arrangement (not shown) by means of which the environment sensor 22 can be adjusted. At least part of the lever arrangement is connected to the drive 30 for the purpose of adjusting the environment sensor 22. In addition, there is a circumferential seal, denoted by the reference designation 29, arranged between the sensor module tray 28 and the roof skin 14.

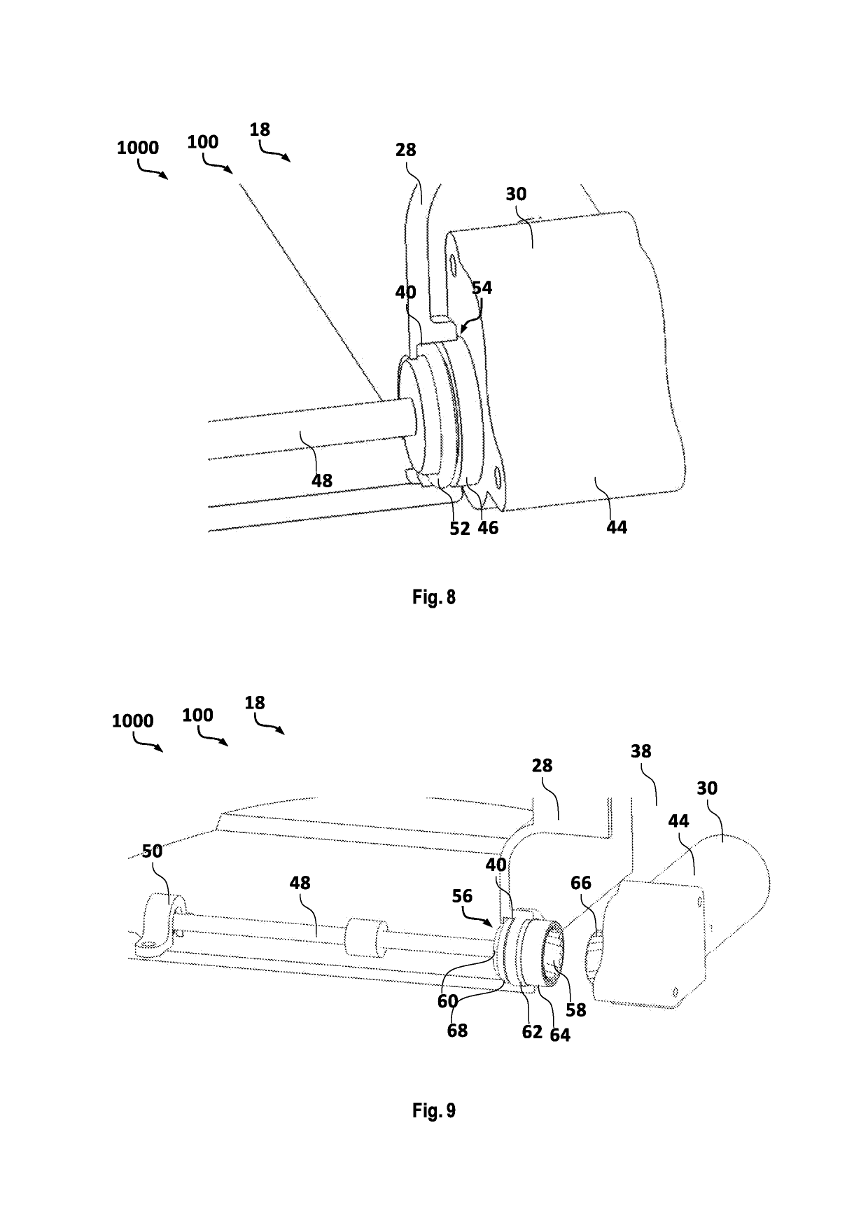

The sensor module tray 28 has an opening 40 that realizes the interface 36, with at least a part of the adjustment mechanism 32 or at least a part of the drive 30 extending through the opening, as shown in particular in FIGS. 7-10. The sensor module tray 28 has a drain 42 through which water can flow out of the wet region 34.

The drive 30 has a drive housing 44, a motor-side bearing arrangement 46 and a drive shaft 48. The drive housing 44 is arranged in the dry region 38 on the sensor module tray 28. The motor-side bearing arrangement 46 extends, at least partly, through the opening 40 into the wet region 34. The drive shaft 48 is arranged in the wet region 34 and is connected to the adjustment mechanism 32 for the purpose of adjusting the environment sensor 22 (not shown explicitly). The drive shaft 48 is supported, or held, by a mounting, or bearing arrangement 50, which is provided in a base region of the sensor module tray 28. The bearing arrangement 50 of the drive shaft 48 is configured to take up axial and radial forces.

The sensor module 18 also has a sealing means 52, which is arranged between the motor-side bearing arrangement 46 and a wall of the sensor module tray 28 that surrounds the opening 40. The sensor module 18 may also have a second sealing means (not shown explicitly), which is arranged between the drive housing 44 and the wall of the sensor module tray 28 that surrounds the opening 40.

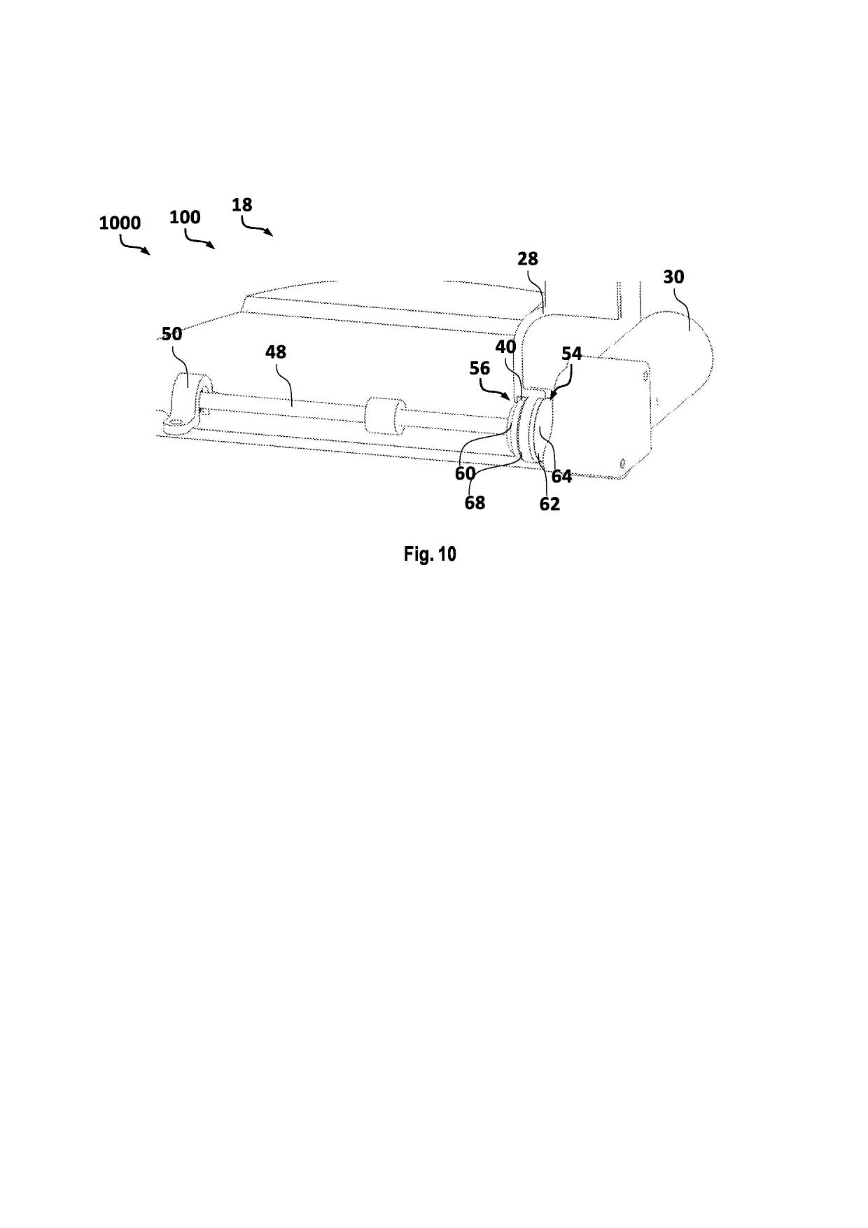

As per the exemplary embodiment shown in FIGS. 9 and 10, the sensor module 18 has a spindle subassembly 56. The spindle subassembly 56 has a coupling element 58, a bearing arrangement 60 and the drive shaft 48, which is connected, in particular integrally, to the coupling element 58. The bearing arrangement 60 of the spindle subassembly 56 is arranged close to the drive 30 for the purpose of taking up axial forces. The spindle subassembly 56 is thus fully supported. The drive 30 is preferably centered by the coupling interface 66, or by a toothed pinion, and mounted on the sensor module tray 28.

The drive 30 has a coupling interface 66. The bearing arrangement 60 is arranged on the coupling element 58 and, starting from the wet region 34, extends through the opening 40 into the dry region 38. The coupling interface 66, starting from the dry region 38, engages in the coupling element 58. The drive housing 44 is arranged in the dry region 38, on the sensor module tray 28.

The spindle subassembly 56 also has a sealing arrangement 68 that is arranged, in particular in a sliding manner, in a wall of the sensor module tray 28 that surrounds the opening 40.

### LIST OF REFERENCE DESIGNATIONS

10 roof sensor module

12 surface component

14 roof skin

16 fixed roof element

18 sensor module

20 covering

22 environment sensor

24 transparency region

26 sensor housing

28 sensor module tray

30 drive

32 adjustment mechanism

34 wet region

36 interface

38 dry region

40 opening

42 drain

44 drive housing

46 motor-side bearing arrangement

48 drive shaft

50 bearing arrangement of the drive shaft

52 sealing means

56 spindle subassembly

58 coupling element

60 bearing arrangement of the spindle subassembly

66 coupling interface

68 sealing arrangement

100 vehicle roof

1000 motor vehicle

1002 vehicle body

x vehicle longitudinal direction

y vehicle width direction

1. A sensor module for a motor vehicle, comprising: an environment sensor for sensing an environment of the vehicle, a sensor module tray, a drive and an adjustment mechanism, the sensor module tray defining a wet region in which the environment sensor and at least a part of the adjustment mechanism are arranged, the sensor module tray realizing an interface to a dry region, and at least a part of the drive being arranged in the dry region and being connected via the interface to the adjustment mechanism for the purpose of adjusting the environment sensor.

2. The sensor module as claimed in claim 1, the sensor module tray having an opening that realizes the interface, at least a part of the adjustment mechanism or at least a part of the drive extending through the opening.

3. The sensor module as claimed in claim 2, the drive having a drive housing, a drive pinion and a drive shaft, the drive housing being arranged in the dry region on the sensor module tray, the drive pinion extending at least partly through the opening into the wet region, and the drive shaft being arranged in the wet region and being connected to the adjustment mechanism for the purpose of adjusting the environment sensor.

4. The sensor module as claimed in claim 3, the sensor module having a sealing means, which is arranged between the drive pinion and a wall of the sensor module tray that surrounds the opening.

5. The sensor module as claimed in claim 4, the sensor module having a second sealing means, is arranged between the drive housing and the wall of the sensor module tray that surrounds the opening.

6. The sensor module as claimed in claim 2, the sensor module having a spindle subassembly, comprising a coupling element, a bearing arrangement and a drive shaft that is connected to the coupling element, the drive having a coupling interface and a drive housing, the bearing arrangement being arranged on the coupling element and, starting from the wet region, extending through the opening into the dry region, the coupling interface, starting from the dry region, engaging in the coupling element, and the drive housing being arranged in the dry region on the sensor module tray.

7. The sensor module as claimed in claim 6, the spindle subassembly having a sealing arrangement that is arranged in a sliding manner, between the bearing arrangement and a wall of the sensor module tray that surrounds the opening.

8. The sensor module as claimed in claim 1, the adjustment mechanism having a lever arrangement by means of which the environment sensor is adjusted, and at least a part of the lever arrangement being connected to the drive for the purpose adjusting the environment sensor.

9. A vehicle roof of a motor vehicle, comprising at least one sensor module as claimed in claim 1.

10. A motor vehicle, comprising a sensor module as claimed in claim 1.

11. The vehicle roof as claimed in claim 9, the vehicle roof realizing a roof sensor module that is arranged as a pre-assembled structural unit on a vehicle body of the motor vehicle.
